(19) United States
(12) Patent Application Publication
(10) Pub. No.: US 2025/0391379 A1
(43) Pub. Date: Dec. 25, 2025

(54) PIXEL CIRCUIT AND DRIVING METHOD THEREFOR, AND DISPLAY PANEL

(71) Applicant: KUNSHAN GO-VISIONOX OPTO-ELECTRONICS CO., LTD., Kunshan (CN)

(72) Inventors: Enqing GUO, Kunshan (CN); Cuili GAI, Kunshan (CN); Junfeng LI, Kunshan (CN); Rubo XING, Kunshan (CN)

(73) Assignee: KUNSHAN GO-VISIONOX OPTO-ELECTRONICS CO., LTD., Kunshan (CN)

(21) Appl. No.: 19/314,268

(22) Filed: Aug. 29, 2025

Related U.S. Application Data
(63) Continuation of application No. PCT/CN2023/110179, filed on Jul. 31, 2023.

(30) Foreign Application Priority Data
Mar. 1, 2023 (CN) 202310187094.7

(51) Int. Cl. G09G 3/3266; G09G 3/32; G09G 3/3233; G09G 3/3291

(52) U.S. Cl. CPC G09G 3/3266; G09G 3/32; G09G 3/3233; G09G 3/3291; G09G 2300/0819; G09G 2300/0852; G09G 2320/0233; G09G 2320/045

(57) ABSTRACT

A pixel circuit and a driving method therefor, and a display panel. The pixel circuit includes a drive circuit, a first storage circuit, and a locking control circuit; where the drive circuit generates a drive current according to a potential difference between a control terminal and a first terminal of the drive circuit; the first storage circuit has a first terminal electrically connected to the control terminal of the drive circuit and a second terminal electrically connected to the first terminal of the drive circuit; a control terminal of the locking control circuit is configured to access a locking control signal, and a first terminal of the locking control circuit is electrically connected to the control terminal of the drive circuit; the second terminal of the first storage circuit or a second terminal of the locking control circuit is configured to access a data signal.

### CROSS-REFERENCES TO RELATED APPLICATIONS

This is a continuation of International Patent Application No. PCT/CN2023/110179, filed on Jul. 31, 2023, which is based on and claims priority to Chinese Patent Application No. 202310187094.7 filed on Mar. 1, 2023, the disclosures of which are incorporated herein by reference in their entireties.

### TECHNICAL FIELD

The present application relates to the field of display technology, for example, a pixel circuit and a driving method therefor, and a display panel.

### BACKGROUND

With the continuous advancement of display technology, the application scope of a display panel has become increasingly extensive, and people's requirements for the display panel have also grown more stringent. The pixel circuit in the display panel plays a crucial role in driving a light-emitting device to maintain stable illumination. However, during the driving process of the pixel circuit, the data writing effect becomes poor, thereby affecting the display effect of the display panel.

### SUMMARY

The present application provides a pixel circuit and a driving method therefor, and a display panel to improve the data writing effect of a display circuit, thereby enhancing the display effect of a display panel.

An embodiment of the present application provides a pixel circuit. The pixel circuit includes a drive circuit, a first storage circuit, and a locking control circuit.

The drive circuit is configured to generate a drive current according to the potential difference between a control terminal of the drive circuit and a first terminal of the drive circuit to drive a light-emitting device to emit light.

A first terminal of the first storage circuit is electrically connected to the control terminal of the drive circuit, and a second terminal of the first storage circuit is electrically connected to the first terminal of the drive circuit.

A control terminal of the locking control circuit is configured to access a locking control signal. A first terminal of the locking control circuit is electrically connected to the control terminal of the drive circuit. The second terminal of the first storage circuit or a second terminal of the locking control circuit is configured to access a data signal.

The locking control circuit is configured to be turned off at a signal locking occasion in response to the locking control signal so that the potential at the control terminal of the drive circuit is in a floating state. The first storage circuit is configured to store a voltage associated with the data signal accessed at the signal locking occasion.

Optionally, the first storage circuit includes a first capacitor. A first terminal of the first capacitor serves as the first terminal of the first storage circuit, and a second terminal of the first capacitor serves as the second terminal of the first storage circuit.

The locking control circuit includes a first transistor. A gate of the first transistor serves as the control terminal of the locking control circuit, a first electrode of the first transistor serves as the first terminal of the locking control circuit, and a second electrode of the first transistor serves as the second terminal of the locking control circuit.

Optionally, the second terminal of the first storage circuit is configured to access the data signal, and the second terminal of the locking control circuit is configured to be connected to a first reference signal line.

The pixel circuit further includes a first data transmission circuit and a second storage circuit.

The first data transmission circuit is configured to be turned on in a data write stage and transmit the data signal to an output terminal of the first data transmission circuit, where the data write stage includes the signal locking occasion.

The second storage circuit is connected between the output terminal of the first data transmission circuit and the second terminal of the first storage circuit and is configured to couple a potential jump at the output terminal of the first data transmission circuit to the second terminal of the first storage circuit.

Optionally, the first data transmission circuit includes a second transistor. A gate of the second transistor is configured to be connected to a first scan line, a first electrode of the second transistor is configured to be connected to a data line, and a second electrode of the second transistor serves as the output terminal of the first data transmission circuit.

The second storage circuit includes a second capacitor. A first terminal of the second capacitor is electrically connected to the output terminal of the first data transmission circuit, and a second terminal of the second capacitor is electrically connected to the second terminal of the first storage circuit.

Optionally, the pixel circuit further includes a first reset circuit, a second reset circuit, and a first light emission control circuit.

The first reset circuit is electrically connected to the output terminal of the first data transmission circuit and is configured to be turned on before the data write stage and reset the second storage circuit by using a first reset signal. The second reset circuit is electrically connected to a second terminal of the drive circuit and is configured to be turned on in a threshold compensation stage to cause the first terminal of the drive circuit to discharge through the drive circuit and the second reset circuit so that the first storage circuit stores a threshold voltage of the drive circuit, where the threshold compensation stage is set before the data write stage.

The first light emission control circuit is connected in series with the drive circuit and the light-emitting device between a first power supply and a second power supply and is configured to be turned on in an initialization stage and a light emission stage, where the initialization stage is set before the threshold compensation stage, and the light emission stage is set after the data write stage.

Optionally, the second terminal of the locking control circuit is configured to access the data signal.

The pixel circuit further includes a second data transmission circuit, a third storage circuit, and a reference signal transmission circuit.

The second data transmission circuit is configured to be turned on in a data write stage and transmit the data signal to an output terminal of the second data transmission circuit, where the data write stage includes the signal locking occasion.

The third storage circuit is connected between the output terminal of the second data transmission circuit and the second terminal of the locking control circuit and is configured to couple a potential jump at the output terminal of the second data transmission circuit to the second terminal of the locking control circuit.

The reference signal transmission circuit is configured to be turned on in response to a transmission control signal and transmit a second reference signal to the second terminal of the first storage circuit, where the reference signal transmission circuit and the locking control circuit are turned off simultaneously or the reference signal transmission circuit is turned off later than the locking control circuit.

Optionally, the locking control signal is reused as the transmission control signal.

Optionally, the second data transmission circuit includes a third transistor. A gate of the third transistor is configured to be connected to a second scan line, a first electrode of the third transistor is configured to be connected to a data line, and a second electrode of the third transistor serves as the output terminal of the second data transmission circuit.

The third storage circuit includes a third capacitor. A first terminal of the third capacitor is electrically connected to the output terminal of the second data transmission circuit, and a second terminal of the third capacitor is electrically connected to the second terminal of the locking control circuit.

The reference signal transmission circuit includes a fourth transistor. A gate of the fourth transistor is configured to be connected to a transmission control signal line, a first electrode of the fourth transistor is connected to a second reference signal line, and a second electrode of the fourth transistor is connected to the second terminal of the first storage circuit.

Optionally, the pixel circuit further includes a third reset circuit, a second light emission control circuit, and a third light emission control circuit.

The third reset circuit is electrically connected to the output terminal of the second data transmission circuit and is configured to reset the third storage circuit by using a second reset signal before the data write stage.

The second light emission control circuit is connected between the first power supply and the second terminal of the drive circuit and is configured to be turned on in a light emission stage, where the light emission stage is set after the data write stage.

The third light emission control circuit is connected between the first terminal of the drive circuit and the anode of the light-emitting device and is configured to be turned on before the data write stage and in the light emission stage.

The second terminal of the first storage circuit is directly electrically connected to the first terminal of the drive circuit or electrically connected to the first terminal of the drive circuit through the third light emission control circuit.

Optionally, a control terminal of the third reset circuit and a control terminal of the third light emission control circuit are connected to the same control signal line.

Optionally, the second terminal of the locking control circuit is configured to access the data signal.

The pixel circuit further includes a fourth storage circuit.

A first terminal of the fourth storage circuit is electrically connected to the second terminal of the first storage circuit, and a second terminal of the fourth storage circuit is electrically connected to the first power supply.

Optionally, the fourth storage circuit includes a fourth capacitor. A first terminal of the fourth capacitor serves as the first terminal of the fourth storage circuit, and a second terminal of the fourth capacitor serves as the second terminal of the fourth storage circuit.

Optionally, the pixel circuit further includes a fourth reset circuit, a fifth reset circuit, and a fourth light emission control circuit.

The fourth reset circuit is electrically connected to the second terminal of the first storage circuit and is configured to be turned on in the initialization stage and turned off in the threshold compensation stage, where the threshold compensation stage is set before the data write stage, the initialization stage is set before the threshold compensation stage, and the data write stage includes the signal locking occasion.

The fifth reset circuit is electrically connected to the first terminal of the first storage circuit and is configured to be turned on before the data write stage and transmit a third reset signal to the first terminal of the first storage circuit.

The fourth light emission control circuit is connected between the first power supply and the second terminal of the drive circuit and is configured to be turned on before the data write stage and in the light emission stage, where the light emission stage is set after the data write stage.

An embodiment of the present application further provides a display panel. The display panel includes the pixel circuit provided by any embodiment of the present application.

An embodiment of the present application further provides a method for driving a pixel circuit. The driving method is configured to drive the pixel circuit provided by any embodiment of the present application. The driving method includes a data write stage and a light emission stage, where the data write stage includes a signal locking occasion.

In the data write stage, the locking control signal controls the locking control circuit to be turned on before the signal locking occasion so that the potential difference between two terminals of the first storage circuit changes with the change of the data signal.

At the signal locking occasion, potential jumping is performed on the locking control circuit, the locking control circuit is controlled to be turned off so that the potential at the control terminal of the drive circuit is in a floating state, and the first storage circuit stores a voltage associated with the data signal accessed at the signal locking occasion.

In the light emission stage, the drive circuit generates a drive current according to the voltage stored by the first storage circuit at the signal locking occasion to drive the light-emitting device to emit light.

In the pixel circuit provided by the embodiments of the present application, by setting the drive circuit, the first storage circuit, and the locking control circuit, a new data writing mode is provided, and the data writing path in the pixel circuit passes through the first storage circuit and the locking control circuit and does not need to pass through the drive circuit. Therefore, the embodiments of the present application can improve the data writing effect of the display circuit, thereby enhancing the display effect of the display panel.

### BRIEF DESCRIPTION OF DRAWINGS

FIG. 1 is a structural diagram of a pixel circuit according to an embodiment of the present application;

FIG. 2 is a structural diagram of another pixel circuit according to an embodiment of the present application;

FIG. 3 is a driving timing graph of a pixel circuit according to an embodiment of the present application;

FIG. 4 is a structural diagram of another pixel circuit according to an embodiment of the present application;

FIG. 5 is a driving timing graph of another pixel circuit according to an embodiment of the present application;

FIG. 6 is a structural diagram of another pixel circuit according to an embodiment of the present application;

FIG. 7 is a structural diagram of another pixel circuit according to an embodiment of the present application;

FIG. 8 is a structural diagram of another pixel circuit according to an embodiment of the present application;

FIG. 9 is a driving timing graph of another pixel circuit according to an embodiment of the present application;

FIG. 10 is a structural diagram of another pixel circuit according to an embodiment of the present application;

FIG. 11 is a structural diagram of another pixel circuit according to an embodiment of the present application;

FIG. 12 is a structural diagram of another pixel circuit according to an embodiment of the present application;

FIG. 13 is a driving timing graph of another pixel circuit according to an embodiment of the present application; and

FIG. 14 is a structure diagram of a display panel according to an embodiment of the present application.

### DETAILED DESCRIPTION

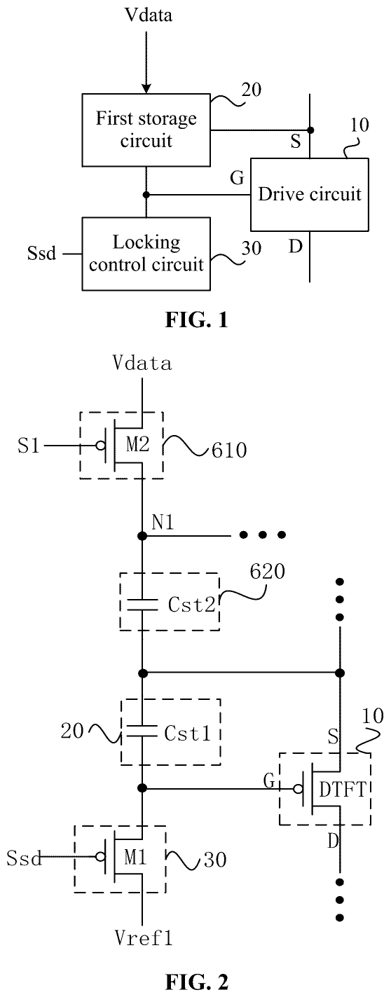

The embodiments of the present application provide a pixel circuit. FIG. 1 is a structural diagram of a pixel circuit according to an embodiment of the present application. As shown in FIG. 1, the pixel circuit includes a drive circuit 10, a first storage circuit 20, and a locking control circuit 30.

The drive circuit 10 is configured to generate a drive current according to a potential difference between a control terminal G of the drive circuit 10 and a first terminal S of the drive circuit 10 to drive a light-emitting device to emit light. A first terminal of the first storage circuit 20 is electrically connected to the control terminal G of the drive circuit 10, and a second terminal of the first storage circuit 20 is electrically connected to the first terminal S of the drive circuit 10. A control terminal of the locking control circuit 30 is configured to access a locking control signal Ssd. A first terminal of the locking control circuit 30 is electrically connected to the control terminal G of the drive circuit 10. The second terminal of the first storage circuit 20 or a second terminal of the locking control circuit 30 is configured to access a data signal Vdata (FIG. 1 shows that the second terminal of the first storage circuit 20 is configured to access the data signal Vdata as an example). The locking control circuit 30 is configured to be turned off at a signal locking occasion in response to the locking control signal Ssd so that the potential at the control terminal G of the drive circuit 10 is in a floating state. The first storage circuit 20 is configured to store a voltage associated with the data signal Vdata accessed at the signal locking occasion.

For example, the drive circuit 10 may include a drive transistor. The gate of the drive transistor serves as the control terminal G of the drive circuit 10, the source of the drive transistor serves as the first terminal S of the drive circuit 10, and the drain of the drive transistor serves as the second terminal D of the drive circuit 10. The second terminal of the first storage circuit 20 or the second terminal of the locking control circuit 30 may directly or indirectly access the data signal Vdata. A connection terminal configured to access the data signal Vdata is defined as a data connection terminal. Directly accessing the data signal Vdata means that the data connection terminal is directly connected to a data line. Indirectly accessing the data signal Vdata means that the data connection terminal is connected to a data line through another circuit, that is, the another circuit processes the data signal Vdata and then transmits a signal including the information about the data signal Vdata to the data connection terminal.

The first storage circuit 20 may include a storage device such as a capacitor, and the storage device such as a capacitor is configured to store the potential difference between the control terminal G and the first terminal S of the drive circuit 10. Taking a capacitor as an example, the memory device has the following characteristics: when two terminals of the capacitor each access a source signal, the potential difference between the two terminals of the capacitor may vary with the change of any source signal; when no source signal is accessed to either terminal of the capacitor and the potential at the terminal is in a floating state, regardless of whether the potential of the source signal at the other terminal of the capacitor changes or not, the potential difference between the two terminals of the capacitor is fixed, and the potential difference stored by the capacitor when the source signal at the terminal at which the potential is in a floating state disappears is maintained; when no source signal is connected to one terminal of the capacitor, in the case where the source signal at the other terminal of the capacitor keeps a fixed potential and does not have any potential change, the potentials at the two terminals of the capacitor do not change, and the potential difference between the two terminals does not change; in the case where the potential of the source signal at the other terminal of the capacitor changes, based on the coupling effect of the capacitor, the potential at the terminal to which no source signal is accessed varies with the change of the source signal, but the potential difference between the two terminals of the capacitor remains unchanged. Based on the above characteristics, one terminal of the first storage circuit 20 may be set to directly or indirectly access the data signal Vdata, and the other terminal of the first storage circuit 20 may be set to directly or indirectly access a fixed power supply. Further, an arbitrary occasion within a row duration in which the data signal Vdata maintains the data voltage required for the current row of pixel circuits may be set as the signal locking occasion. The row duration may be understood as a duration during which the data signal Vdata maintains the data voltage required for one row of pixel circuits or an interval duration during which the data signal Vdata is refreshed. At the signal locking occasion, the first storage circuit 20 may be controlled to be disconnected from the data signal Vdata and/or the fixed power supply so that the first storage circuit 20 stores a voltage associated with the data signal Vdata accessed at the signal locking occasion. The voltage stored by the first storage circuit 20 may be a potential difference between two terminals of the first storage circuit 20. The voltage associated with the data signal Vdata may be understood as a voltage carrying information about the data signal Vdata, for example, a voltage having a multiple relationship with the data voltage or a voltage computable through a functional relationship with the data voltage, where the functional relationship is derived from both the data transmission process and the storage characteristics of the first storage circuit 20.

The locking control circuit 30 may include a switch device such as a transistor. The locking control circuit 30 may be arranged at one terminal of the first storage circuit 20 for connecting a fixed power supply or may be arranged at one terminal of the first storage circuit 20 for receiving the data signal Vdata. The potential jumping occasion at which the locking control signal Ssd changes from the turn-on potential to the cut-off potential of the locking control circuit 30 may serve as the signal locking occasion. Taking the arrangement where the locking control circuit 30 is arranged at one terminal of the first storage circuit 20 for connecting a fixed power supply as an example, at the potential jumping edge where the locking control signal Ssd changes from the turn-on potential to the cut-off potential, the locking control circuit 30 is disconnected so that the potential at the control terminal G of the drive circuit 10 is in a floating state, the source of the fixed power supply of the first storage circuit 20 is cut off, and the first storage circuit 20 may store and maintain the potential difference at the potential jumping occasion of the locking control signal Ssd. For example, when the locking control circuit 30 is arranged at one terminal of the first storage circuit 20 for connecting a fixed power supply, the pixel circuit may further include a data write circuit, such as a transistor, and such a transistor is connected to the other terminal of the first storage circuit 20 and is configured to control whether to transmit the data signal Vdata to the first storage circuit 20. When the locking control circuit 30 is arranged at one terminal of the first storage circuit 20 for receiving the data signal Vdata, the pixel circuit may further include an auxiliary storage device, such as a capacitor, and such a capacitor is connected to the other terminal of the first storage circuit 20 to indirectly supply a fixed power supply signal to the other terminal of the first storage circuit 20.

As can be seen from the above analysis, for the pixel circuit provided in the embodiments of the present application, the data writing path passes through the first storage circuit 20 and the locking control circuit 30 and does not need to pass through the channel of the drive transistor. At the potential jumping edge of the locking control signal Ssd, that is, at the signal locking occasion, the potential stored by the first storage circuit 20 is locked, and then the data writing process is completed. Therefore, in the embodiments of the present application, there is no need to wait for the slow change process of the gate potential of the drive transistor, thereby achieving fast data writing. As long as the data write stage includes the signal locking occasion and the signal locking occasion is within the row duration during which the data signal Vdata maintains the data voltage required for the current row of pixel circuits, the first storage circuit 20 may be controlled to correctly store the voltage signal associated with the data voltage of the current row, thereby achieving the correct data writing process.

The duration of the data write stage may exceed the row duration, and in this embodiment, data voltage information of an adjacent row is allowed to enter the current row of pixel circuits. Before the potential jump of the locking control signal Ssd, the potentials at multiple nodes in the data writing path may vary with the voltage change of the data signal Vdata, and compared with the pixel circuit (for example, a pixel circuit having a 7T1C architecture) in the related art, the risk of irreversible data writing caused by the inability of the data voltage of a next row to activate the drive transistor is eliminated, so the data voltage of a previous row or the data voltages of more rows is allowed to enter the current row of pixel circuits. Moreover, after the potential jump of the locking control signal Ssd, the potential difference between the control terminal G and the first terminal S of the drive circuit 10 is maintained by the first storage circuit 20, and even if the voltage jump of the data signal Vdata occurs, the maintaining of the potential difference between the control terminal G and the first terminal S of the drive circuit 10 is not affected. Therefore, the width of the on-pulse of the control signal related to the data writing process may be greater than the row duration, thereby effectively reducing the risk of malfunctions of a scanning circuit for providing the control signal, improving the stability of the control signal, and ensuring the data writing effect.

In the subsequent light emission stage, the locking control signal Ssd is maintained at the cut-off potential to keep the locking control circuit 30 off, the first storage circuit 20 maintains the voltage stored at the signal locking occasion, and the drive circuit 10 generates a drive current according to the voltage to drive the light-emitting device to emit light at a target brightness which corresponds to the data signal Vdata at the signal locking occasion.

In summary, in the pixel circuit provided by the embodiments of the present application, by setting the drive circuit 10, the first storage circuit 20, and the locking control circuit 30, a new data writing mode is provided. In this data writing mode, the data writing path in the pixel circuit passes through the first storage circuit 20 and the locking control circuit 30 and does not need to pass through the drive circuit 10. Therefore, by controlling the locking control circuit 30 to change from the on state to the off state at the signal locking occasion, the data information at the occasion may be locked so that the first storage circuit 20 may quickly and correctly store the voltage associated with the data signal Vdata accessed at the signal locking occasion, and further, by setting the data write stage to include the signal locking occasion and the signal locking occasion to be within the row duration in which the data signal Vdata maintains the data voltage required for the current row of pixel circuits, the correct data writing process can be achieved. The duration of the data write stage is not limited in this embodiment, and data voltage information of an adjacent row is allowed to enter the current row of pixel circuits in the data write stage, so the width of the on-pulse of the control signal related to the data writing process may be greater than the row duration, thereby effectively reducing the risk of malfunctions of a scanning circuit for providing the control signal, improving the stability of the control signal, and ensuring the data writing effect. In this manner, the width of the on-pulse of the control signal related to the data writing process may be greater than the row duration, thereby effectively reducing the risk of malfunctions of the scanning circuit, improving the stability of the control signal, and ensuring the data writing effect. Therefore, the structure of the pixel circuit provided by the embodiments of the present application can improve the data writing effect of the display circuit, thereby enhancing the display effect of the display panel.

In the preceding embodiments, functional circuits in the pixel circuit are described in terms of their functionality. Hereinafter, the possible structures that the functional circuit may have are described, and other functional circuits and control timings that may be involved in the pixel circuit are explained.

FIG. 2 is a structural diagram of another pixel circuit according to an embodiment of the present application. With reference to FIG. 2, on the basis of the preceding embodiments, optionally, the first storage circuit 20 includes a first capacitor Cst1. A first terminal of the first capacitor Cst1 serves as the first terminal of the first storage circuit 20, and a second terminal of the first capacitor Cst1 serves as the second terminal of the first storage circuit 20. In this embodiment, by setting the first storage circuit 20 to include one capacitor, the structure of the first storage circuit 20 is simplified and becomes easier to achieve.

With continued reference to FIG. 2, on the basis of the preceding embodiments, optionally, the locking control circuit 30 includes a first transistor M1. A gate of the first transistor M1 serves as the control terminal of the locking control circuit 30, a first electrode of the first transistor v serves as the first terminal of the locking control circuit 30, and a second electrode of the first transistor M1 serves as the second terminal of the locking control circuit 30. In this embodiment, by setting the locking control circuit 30 to be composed of one transistor, the structure of the locking control circuit 30 is simplified and becomes easy to achieve.

With continued reference to FIG. 2, in an embodiment, optionally, the second terminal of the first storage circuit 20 is configured to indirectly access the data signal Vdata, and the second terminal of the locking control circuit 30 is connected to a first reference signal line and accesses a first reference signal Vref1. The first reference signal Vref1 is, for example, a direct current signal having a fixed potential.

FIG. 2 mainly shows the structure related to the data writing process in the pixel circuit. For example, in addition to the first storage circuit 20 and the locking control circuit 30, the structure related to the data writing process further includes a first data transmission circuit 610 and a second storage circuit 620 to assist in data writing. The second storage circuit 620 is connected between an output terminal of the first data transmission circuit 610 and a second terminal of the first storage circuit 610. The first data transmission circuit 610 is configured to be turned on in the data write stage and transmit the data signal Vdata to the output terminal of the first data transmission circuit 610. The second storage circuit 620 is configured to couple a potential jump at the output terminal of the first data transmission circuit 610 to the second terminal of the first storage circuit 20. The data write stage includes the signal locking occasion.

The first data transmission circuit 610 includes a second transistor M2. A gate of the second transistor M2 is connected to a first scan line and accesses a first scanning signal S1, a first electrode of the second transistor M2 is connected to a data line and accesses the data signal Vdata, and a second electrode of the second transistor M2 serves as the output terminal of the first data transmission circuit 610. The second storage circuit 620 includes a second capacitor Cst2. A first terminal N1 of the second capacitor Cst2 is electrically connected to the output terminal of the first data transmission circuit 610, and a second terminal of the second capacitor Cst2 is electrically connected to the second terminal of the first storage circuit 20.

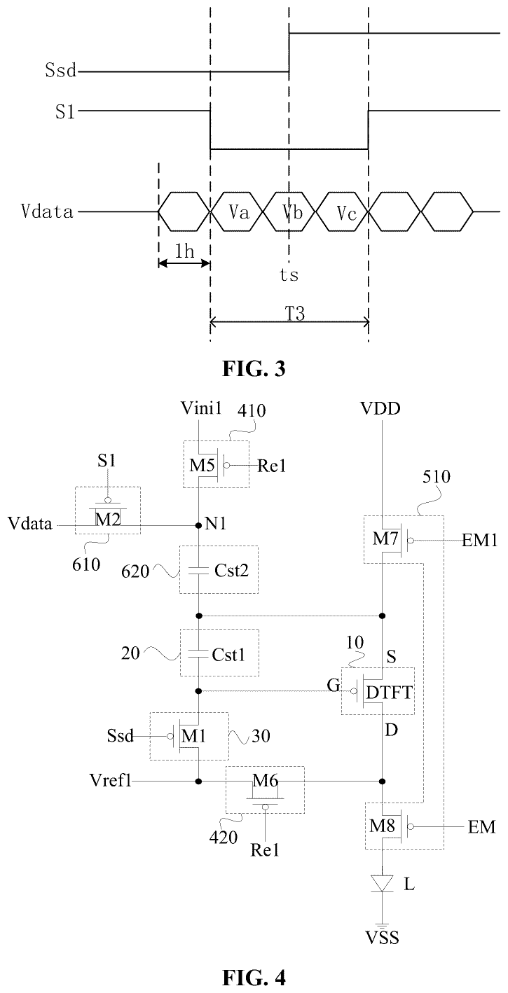

In conjunction with FIG. 3, taking all the transistors being p-type transistors as an example, the data writing process of the pixel circuit is described below. For example, for the data signal Vdata, a data voltage Vb is a data voltage required for the current row of pixel circuits, a data voltage Va is the data voltage of the previous row, and a data voltage Vc is the data voltage of the next row. Taking the data write stage T3 lasting three row durations h, the data write stage T3 of the pixel circuit includes the following.

Before the signal locking occasion ts, the locking control signal Ssd and the first scanning signal S1 are each at a logic low potential. Both the first transistor M1 and the second transistor M2 are turned on, the first reference signal Vref1 is transmitted to the first terminal of the first capacitor Cst1 after passing through the first transistor M1, and the data signal Vdata is transmitted to the first terminal N1 of the second capacitor Cst2 after passing through the second transistor M2. When the data signal Vdata changes from the data voltage Va to the data voltage Vb, the second capacitor Cst2 couples the potential change of the first terminal N1 of the second capacitor Cst2 to the second terminal of the first capacitor Cst1, and the potential difference between two terminals of the first capacitor Cst1 varies with the potential change of the second terminal of the first capacitor Cst1.

The signal locking occasion ts is located within the duration in which the data signal Vdata maintains the data voltage Vb. At the signal locking occasion ts, a rising edge of the locking control signal Ssd appears, the locking control signal Ssd jumps up to a logic high potential, and the first scanning signal S1 is maintained at a logic low potential. The first transistor M1 is turned off, and the second transistor M2 is turned on. The first terminal of the first capacitor Cst1 (that is, the gate of the drive transistor DTFT) is in a floating state, the fixed signal source of the first capacitor Cst1 is cut off, and the potential difference between two terminals of the first capacitor Cst1 is locked. At this point, the information about the data signal Vdata is stored in the first capacitor Cst1.

After the signal locking occasion ts, the locking control signal Ssd is at a logic high potential, and the first scanning signal S1 is maintained at a logic low potential. The first transistor M1 is turned off, and the second transistor M2 is turned on. The first terminal of the first capacitor Cst1 remains floating, and the data signal Vdata is transmitted to the first terminal N1 of the second capacitor Cst2 after passing through the second transistor M2. When the data signal Vdata changes from the data voltage Vb to the data voltage Vc, the potentials at the first terminal N1 of the second capacitor Cst2, the first terminal of the first capacitor Cst1, and the second terminal of the first capacitor Cst1 change accordingly, but the potential difference between the two terminals of the first capacitor Cst1 remains unchanged and is still the potential difference at the signal locking occasion ts.

As can be seen from the above, although the width of the on-pulse of the first scanning signal S1 is larger than the row duration h, the three data voltage values of the data signal Vdata successively enter the first terminal N1 of the second capacitor Cst2 in the data write stage T3, but only the voltage associated with the data voltage Vb is actually collected and locked by the first capacitor Cst1.

The complete pixel circuit employing the above data write structure is described below. FIG. 4 is a structural diagram of another pixel circuit according to an embodiment of the present application. With reference to FIG. 4, on the basis of the preceding embodiments, optionally, the pixel circuit further includes a first reset circuit 410, a second reset circuit 420, and a first light emission control circuit 510. The first reset circuit 410 is electrically connected to the output terminal of the first data transmission circuit 610. The second reset circuit 420 is electrically connected to the second terminal D of the drive circuit 10. The first light emission control circuit 510 is connected in series with the drive circuit 10 and the light-emitting device L between a first power supply and a second power supply.

The first reset circuit 410 includes a fifth transistor M5. A gate of the fifth transistor M5 accesses a first control signal Re1, a first electrode of the fifth transistor M5 accesses a first reset signal Vini1, and a second electrode of the fifth transistor M5 is electrically connected to the output terminal of the first data transmission circuit 610. The second reset circuit 420 includes a sixth transistor M6. A gate of the sixth transistor M6 accesses the first control signal Re1, a first electrode of the sixth transistor M6 accesses the first reference signal Vref1, and a second electrode of the sixth transistor M6 is electrically connected to the second terminal D of the drive circuit 10. The first light emission control circuit 510 includes a seventh transistor M7 and an eighth transistor M8. A gate of the seventh transistor M7 and a gate of the eighth transistor M8 both access a first light emission control signal EM1, a first electrode of the seventh transistor M7 is connected to the first power supply and accesses a first power supply signal VDD, and a second electrode of the seventh transistor M7 is electrically connected to the first terminal S of the drive circuit 10. A first electrode of the eighth transistor M8 is electrically connected to the second terminal D of the drive circuit 10, a second electrode of the eighth transistor M8 is electrically connected to the anode of the light-emitting device L, and the cathode of the light-emitting device L is connected to the second power supply and accesses a second power supply signal VSS. The first power supply signal VDD and the second power supply signal VSS are direct current signals having different potentials. For example, the first power supply signal VDD is a high potential signal, and the second power supply signal VSS is a low potential signal. The first reset signal Vini1 may be a direct current signal having a fixed potential.

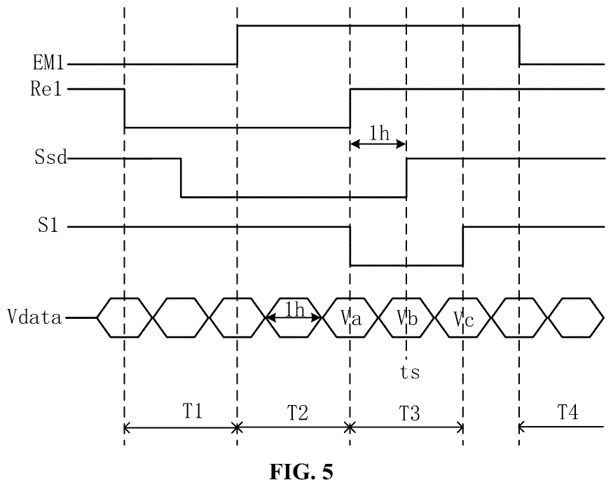

FIG. 5 is a driving timing graph of another pixel circuit according to an embodiment of the present application. In conjunction with FIGS. 4 and 5, for example, the driving process of the pixel circuit includes an initialization stage T1, a threshold compensation stage T2, a data write stage T3, and a light emission stage T4.

In the initialization stage T1, the first light emission control signal EM1 is at a logic low potential, and both the seventh transistor M7 and the eighth transistor M8 are turned on. The first scanning signal S1 is at a logic high potential, and the second transistor M2 is turned off. When the low-potential pulses of the first control signal Re1 and the locking control signal Ssd arrive successively, the first transistor M1, the fifth transistor M5, and the sixth transistor M6 are all on. The first reset signal Vini1 is transmitted to the first terminal N1 of the second capacitor Cst2 after passing through the fifth transistor M5. The first reference signal Vref1 is transmitted to the gate of the drive transistor DTFT after passing through the first transistor M1. Meanwhile, the first reference signal Vref1 is transmitted to the drain of the drive transistor DTFT after passing through the sixth transistor M6 and then transmitted to the anode of the light-emitting device L after passing through the eighth transistor M8 to reset the anode of the light-emitting device L. The first power supply signal VDD is transmitted to the source of the drive transistor DTFT after passing through the seventh transistor M7. In the initialization stage, both the first capacitor Cst1 and the second capacitor Cst2 are discharged and reset.

In the threshold compensation stage T2, the first control signal Re1 and the locking control signal Ssd are each at a logic low potential, and the first scanning signal S1 and the first light emission control signal EM1 are each at a logic high potential. Both the seventh transistor M7 and the eighth transistor M8 are turned off. The first reset signal Vini1 continues to be transmitted to the first terminal N1 of the second capacitor Cst2 after passing through the fifth transistor M5. The first reference signal Vref1 continues to be transmitted to the gate of the drive transistor DTFT after passing through the first transistor M1. The source of the drive transistor DTFT is discharged through the drive transistor DTFT and the sixth transistor M6, the drive transistor DTFT is turned off when the potential at the source of the drive transistor DTFT gradually decreases from the potential of the first power supply signal VDD to Vref1−Vth1, and then the threshold compensation to the drive transistor DTFT is completed. At this point, the stored potential difference between two terminals of the first capacitor Cst1 is a threshold voltage Vth1 of the drive transistor DTFT.

In the data write stage T3, when the data write stage is just entered, the locking control signal Ssd and the first scanning signal S1 are each at a logic low potential, and the first control signal Re1 and the first light emission control signal EM1 are each at a logic high potential. The fifth transistor M5 and the sixth transistor M6 are off, and the first transistor M1 and the second transistor M2 remain on. The data signal Vdata is written to the first terminal N1 of the second capacitor Cst2 after passing through the second transistor M2 so that the potential at the first terminal N1 of the second capacitor Cst2 jumps from the first reset signal Vini1 to the data voltage Va of the data signal Vdata. The first reference signal Vref1 continues to be transmitted to the gate of the drive transistor DTFT after passing through the first transistor M1. Due to the potential jump at the first terminal N1 of the second capacitor Cst2, the potential jump amount of the first terminal N1 of the second capacitor Cst2 coupled to the second terminal of the first capacitor Cst1 through the second capacitor Cst2 is (Vdata−Vini1)·(Cst2)/(Cst1+Cst2+Cgs). Therefore, the potential difference between the two terminals of the first capacitor Cst1 is Vth1+(Vdata−Vini1)·(Cst2)/(Cst1+Cst2+Cgs), where Cgs denotes the capacitance between the gate of the drive transistor DTFT and the source of the drive transistor DTFT.

At the signal locking occasion ts, the locking control signal Ssd jumps up to a logic high potential, the first transistor M1 is turned off, and the first terminal of the first capacitor Cst1 (that is, the gate of the drive transistor DTFT) is in a floating state. At this point, the data signal Vdata maintains the data voltage Vb, and thus the potential difference between the two terminals of the first capacitor Cst1 is locked as: Vth1+(Vb−Vini1)·(Cst2)/(Cst1+Cst2+Cgs). That is, both the information about the data signal Vdata of the current row and the threshold voltage information of the drive transistor DTFT are stored in the first capacitor Cst1. For example, the rising edge of the first control signal Re1 may be set to be one row duration (that is, 1 h) ahead of the rising edge of the locking control signal Ssd.

After the signal locking occasion ts, the locking control signal Ssd is maintained at a logic high potential, the first transistor M1 is turned off, and the first terminal of the first capacitor Cst1 is still in a floating state. The data signal Vdata may still be transmitted to the first terminal N1 of the second capacitor Cst2 after passing through the second transistor M2. When the data signal Vdata jumps to the data voltage Vc, the voltage enters the pixel circuit. However, the potential jump amount coupled by the second capacitor Cst2 to the second terminal of the first capacitor Cst1 is simultaneously coupled by the first capacitor Cst1 to the first terminal of the first capacitor Cst1, and thus the data voltage is actually invalidated. Therefore, the potential difference between the two terminals of the first capacitor Cst1 remains Vth1+(Vb−Vini1)·(Cst2)/(Cst1+Cst2+Cgs).

In the light emission stage T4, the first light emission control signal EM1 is at a logic low potential, and the first control signal Re1, the locking control signal Ssd, and the first scanning signal S1 are each at a logic high potential. The first transistor M1, the second transistor M2, the fifth transistor M5, and the sixth transistor M6 are all turned off, the seventh transistor M7 and the eighth transistor M8 are turned on, and the drive transistor DTFT generates a drive current to light the light-emitting device L. The drive current is a function of Vgs−Vth1, where Vgs is equal to the voltage difference between the two terminals of the first capacitor Cst1. When the structure of the pixel circuit is determined, the first capacitor Cst1, the second capacitor Cst2, and Cgs are determined as fixed values accordingly. Therefore, the drive current is actually a function of Vdata−Vini1, that is, the magnitude of the drive current is independent of the threshold voltage Vth1 of the drive transistor DTFT, thereby achieving the threshold compensation.

In summary, the time span of the data write stage T3 exceeds one row duration h. In this embodiment, in the data write stage T3, although the data signal Vdata has three values, only the data voltage Vb at the signal locking occasion ts is valid for the current row of pixel circuits, and the rising edge of the locking control signal Ssd is equivalent to a sampling operation to lock the data voltage Vb and store the data voltage Vb in the first capacitor Cst1. Although the data voltages of adjacent rows may enter the circuit, these voltages are all actually invalidated. The embodiments of the present application generally provide a 7T2C pixel circuit architecture. The threshold compensation process is separated from the data writing process during the driving process. The threshold compensation duration is prolonged, and the threshold compensation effect on the drive transistor DTFT is improved, thereby enhancing the brightness uniformity of the display panel and simultaneously achieving a high refresh rate and a high resolution of the display panel.

For example, the transistors in the pixel circuit may all be p-type transistors and are manufactured by a low-temperature polycrystalline silicon (LTPS) process to make full use of the advantages of LTPS transistors such as high mobility, strong driving ability, and mature technology and reduce the manufacturing cost of the display panel.

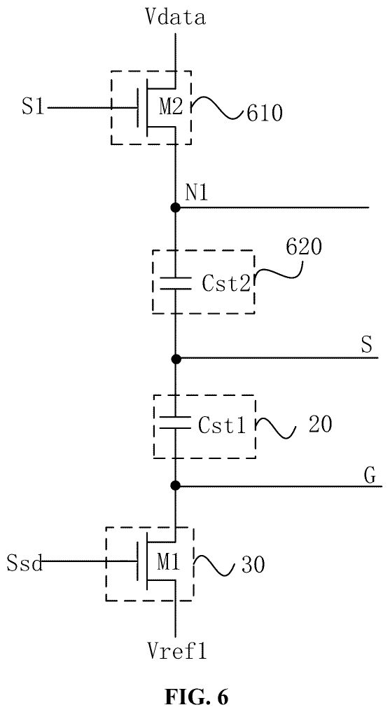

The preceding embodiments illustrate the solution where the transistors in the pixel circuit are all p-type transistors, which should not be construed as limiting the present application. In other embodiments, some or all of the transistors may be replaced with n-type transistors according to the requirements, and the potentials of the control signals accessed to the transistors may be adjusted accordingly. For example, as shown in FIG. 6, the transistors in the related structure for data writing may all be replaced with n-type transistors.

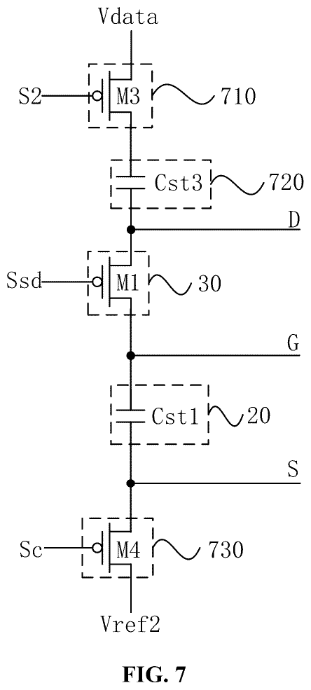

FIG. 7 is a structural diagram of another pixel circuit according to an embodiment of the present application. FIG. 7 mainly shows the structure related to the data writing process. With reference to FIG. 7, in another embodiment, optionally, the second terminal of the locking control circuit 30 is configured to indirectly access the data signal Vdata. For example, in addition to the first storage circuit 20 and the locking control circuit 30, the structure related to the data writing process further includes a second data transmission circuit 710, a third storage circuit 720, and a reference signal transmission circuit 730. The third storage circuit 720 is connected between an output terminal of the second data transmission circuit 710 and the second terminal of the locking control circuit 30, and the reference signal transmission circuit 730 is electrically connected to the second terminal of the first storage circuit 20. The second data transmission circuit 710 is configured to be turned on in the data write stage and transmit the data signal Vdata to the output terminal of the second data transmission circuit 710. The third storage circuit 720 is configured to couple a potential jump at the output terminal of the second data transmission circuit 710 to the second terminal of the locking control circuit 30. The reference signal transmission circuit 730 is configured to be turned on in response to a transmission control signal Sc and transmit a second reference signal Vref2 to the second terminal of the first storage circuit 20. The transmission control signal Sc controls the reference signal transmission circuit 730 and the locking control circuit 30 to turned off simultaneously or controls the reference signal transmission circuit 730 to be turned off later than the locking control circuit 30, thereby avoiding the inability of the first storage circuit 20 to correctly store the voltage associated with the data signal Vdata at the signal locking occasion ts due to premature floating of the second terminal of the first storage circuit 20. The second reference signal Vref2 is, for example, a direct current signal having a fixed potential.

Optionally, the locking control signal Ssd may be set to be reused as the transmission control signal Sc, thereby controlling the locking control circuit 30 and the reference signal transmission circuit 730 to be simultaneously turned off at the signal locking occasion ts. Through the above arrangement, the number of signal lines in the display panel can be reduced, and the structure of the display panel can be simplified, thereby facilitating the wiring design of the display panel.

The second data transmission circuit 710 includes a third transistor M3. A gate of the third transistor M3 is connected to a second scan line and accesses a second scanning signal S2, a first electrode of the third transistor M3 is connected to a data line and accesses the data signal Vdata, and a second electrode of the third transistor M3 serves as the output terminal of the second data transmission circuit 710. The third storage circuit 720 includes a third capacitor Cst3. A first terminal of the third capacitor Cst3 is electrically connected to the output terminal of the second data transmission circuit 710, and a second terminal of the third capacitor Cst3 is electrically connected to the second terminal of the locking control circuit 30. The reference signal transmission circuit 730 includes a fourth transistor M4. A gate of the fourth transistor M4 is connected to a transmission control signal line and accesses the transmission control signal Sc, a first electrode of the fourth transistor M4 is connected to a second reference signal line and accesses the second reference signal Vref2, and a second electrode of the fourth transistor M4 is connected to the second terminal of the first storage circuit 20.

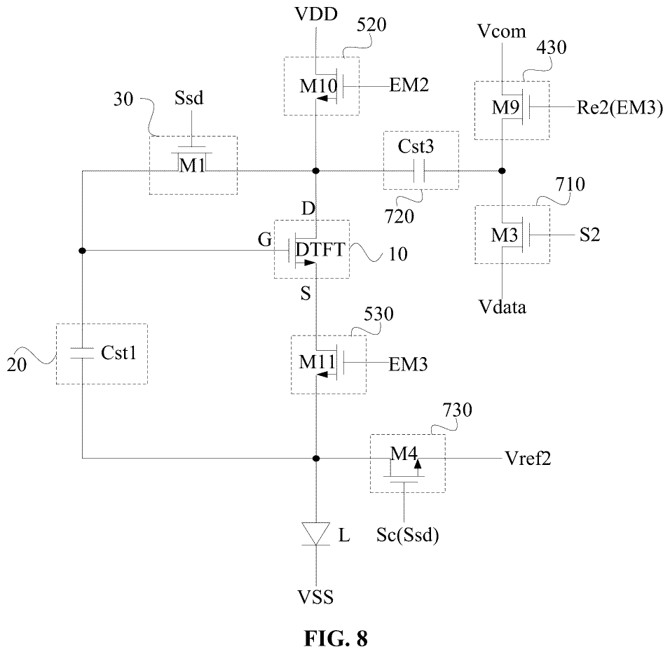

The application of the above data write structure is described below in conjunction with the pixel circuit employing the structure. FIG. 8 is a structural diagram of another pixel circuit according to an embodiment of the present application. With reference to FIG. 8, on the basis of the preceding embodiments, optionally, the pixel circuit further includes a third reset circuit 430, a second light emission control circuit 520, and a third light emission control circuit 530. The third reset circuit 430 is electrically connected to the output terminal of the second data transmission circuit 710. The second light emission control circuit 520 is connected between the first power supply and the second terminal D of the drive circuit 10, and the third light emission control circuit 530 is connected between the first terminal S of the drive circuit 10 and the anode of the light-emitting device L.

The third reset circuit 430 includes a ninth transistor M9. A gate of the ninth transistor M9 accesses a second control signal Re2, a first electrode of the ninth transistor M9 accesses a second reset signal Vcom, and a second electrode of the ninth transistor M9 is electrically connected to the output terminal of the second data transmission circuit 710. The second light emission control circuit 520 includes a tenth transistor M10. A gate of the tenth transistor M10 accesses a second light emission control signal EM2, a first electrode of the tenth transistor M10 accesses the first power supply signal VDD, and a second electrode of the tenth transistor M10 is electrically connected to the drain of the drive transistor DTFT. The third light emission control unit 530 includes an eleventh transistor M11. A gate of the eleventh transistor M11 accesses a third light emission control signal EM3, a first electrode of the eleventh transistor M11 is electrically connected to the source of the drive transistor DTFT (that is, the first terminal S of the drive circuit 10), and a second electrode of the eleventh transistor M11 is electrically connected to the anode of the light-emitting device L. The second reset signal Vcom is, for example, a direct current signal having a fixed potential.

Optionally, a control terminal of the third reset circuit 430 and a control terminal of the third light emission control circuit 530 may be connected to the same control signal line, that is, the third light emission control signal EM3 is reused as the second control signal Re2, thereby reducing the number of signal lines in the display panel.

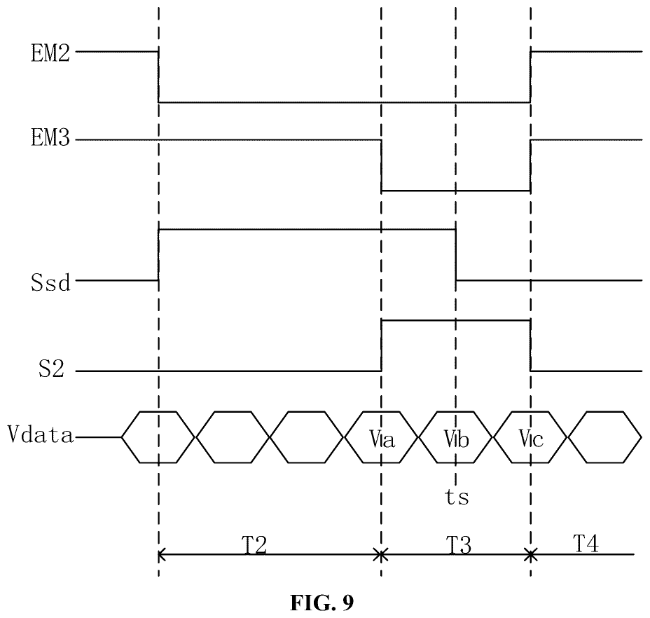

FIG. 9 is a driving timing graph of another pixel circuit according to an embodiment of the present application. In conjunction with FIGS. 8 and 9, taking the locking control signal Ssd being reused as the transmission control signal Sc, the third light emission control signal EM3 being reused as the second control signal Re2, and the transistors all being n-type transistors as an example, the driving process of the pixel circuit includes a threshold compensation stage T2, a data write stage T3, and a light emission stage T4.

In the threshold compensation stage T2, the locking control signal Ssd and the third light emission control signal EM3 are each at a logic high potential, and the second scanning signal S2 and the second light emission control signal EM2 are each at a logic low potential. The first transistor M1, the fourth transistor M4, the ninth transistor M9, and the eleventh transistor M11 are all turned on, and the third transistor M3 and the tenth transistor M10 are turned off. The second reset signal Vcom is transmitted to the first terminal of the third capacitor Cst3 after passing through the ninth transistor M9. The second reference signal Vref2 is transmitted to the anode of the light-emitting device L after passing through the fourth transistor M4 and then transmitted to the source of the drive transistor DTFT after passing through the eleventh transistor M11. The first power supply signal VDD is transmitted to the drain of the drive transistor DTFT after passing through the tenth transistor M10 and then transmitted to the gate of the drive transistor DTFT after passing through the eleventh transistor M11. At the start of the threshold compensation stage T2, the potential at the gate of the drive transistor DTFT is instantaneously raised to a level slightly lower than the first power supply signal VDD to control the drive transistor DTFT to be turned on, and the drive current starts from the drain of the drive transistor DTFT, flows through the drive transistor DTFT, the eleventh transistor M11, and the fourth transistor M4, and is transmitted towards the second reference signal line (which is a signal line set to provide the second reference signal Vref2) until the potentials at the gate and the drain of the drive transistor DTFT drop to Vref2+Vth1. At this point, the stored potential difference between two terminals of the first capacitor Cst1 is the threshold voltage Vth1 of the drive transistor DTFT.

In the data write stage T3, when the data write stage T3 is just entered, the third light emission control signal EM3 jumps to a logic low potential, the second scanning signal S2 jumps to a logic high potential, the locking control signal Ssd is maintained at a logic high potential, and the second light emission control signal EM2 is maintained at a logic low potential. The ninth transistor M9 and the eleventh transistor M11 are off, and the third transistor M3 is turned on. The data signal Vdata is written to the first terminal of the third capacitor Cst3 after passing through the third transistor M3 so that the potential at the first terminal of the third capacitor Cst3 jumps from the second reset signal Vcom to the data voltage Va of the data signal Vdata. The potential at the source of the drive transistor DTFT is in a floating state, and the potential of the second reference signal Vref2 is maintained. The second reset signal Vcom is transmitted to the first terminal of the third capacitor Cst3 after passing through the ninth transistor M9. Due to the potential jump at the first terminal of the third capacitor Cst3, when the potential jump amount is coupled by the third capacitor Cst3 and transmitted to the first terminal of the first capacitor Cst1 after passing through the first transistor M1, the potential jump amount is (Vdata−Vcom)·(Cst3)/(Cst1+Cst3+Cgs). Therefore, the potential difference between the two terminals of the first capacitor Cst1 is Vth1+(Vdata−Vcom)·(Cst3)/(Cst1+Cst3+Cgs), where Cgs denotes the capacitance between the gate of the drive transistor DTFT and the source of the drive transistor DTFT.

At the signal locking occasion ts, the falling edge of the locking control signal Ssd comes, the locking control signal falls to a logic low potential, the first transistor M1 and the fourth transistor M4 are off, the first terminal and the second terminal of the first capacitor Cst1 are floating, and the data signal source and the fixed signal source of the first capacitor Cst1 are both cut off. At this point, the data signal Vdata is the data voltage Vb, and thus the potential difference between the two terminals of the first capacitor Cst1 is locked as: Vth1+ (Vb−Vcom)·(Cst3)/(Cst1+Cst3+Cgs). That is, both the information about the data signal Vdata of the current row and the threshold voltage information of the drive transistor DTFT are stored in the first capacitor Cst1.

After the signal locking occasion ts, the locking control signal Ssd is maintained at a logic low potential, the first transistor M1 and the fourth transistor M4 remain off, and the data signal Vdata may still be transmitted to the first terminal of the third capacitor Cst3 after passing through the third transistor M3. However, since the first transistor M1 is turned off, the potential jump amount coupled by the third capacitor Cst3 cannot be transmitted to the first terminal of the first capacitor Cst1, and thus the potential difference between the two terminals of the first capacitor Cst1 remains Vth1+(Vb−Vcom)·(Cst3)/(Cst1+Cst3+Cgs).

In the light emission stage T4, the second light emission control signal EM2 and the third light emission control signal EM3 are each at a logic high potential, and the locking control signal Ssd and the second scanning signal S2 are each at a logic low potential. The first transistor M1, the third transistor M3, and the fourth transistor M4 are all turned off. The tenth transistor M10 and the eleventh transistor M11 are turned on, and the drive transistor DTFT generates a drive current to light the light-emitting device L. The ninth transistor M9 is turned on, the second reset signal Vcom is transmitted to the first terminal of the third capacitor Cst3 after passing through the ninth transistor M9, and then the third capacitor Cst3 is reset. Similarly, since the drive current is a function of Vgs-Vth1, where Vgs is equal to the voltage difference between the two terminals of the first capacitor Cst1, the drive current is actually a function of (Vb−Vcom)·(Cst3)/(Cst1+Cst3+Cgs), and the drive current is independent of the threshold voltage Vth1 of the drive transistor DTFT.

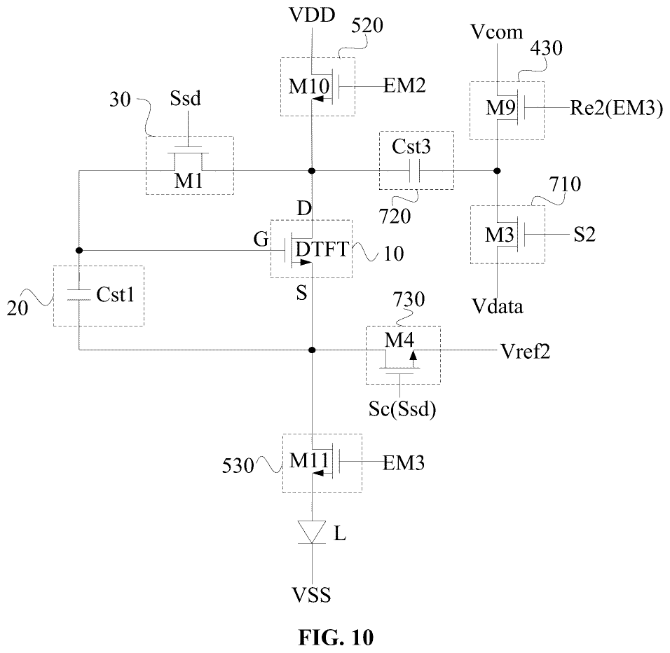

The preceding embodiments illustrate the solution where the second terminal of the first capacitor Cst1 is indirectly connected to the source of the drive transistor DTFT, that is, the second terminal of the first capacitor Cst1 is connected to the source of the drive transistor DTFT after passing through the eleventh transistor M11, which should not be construed as limiting the present application. In other embodiments, as shown in FIG. 10, the second terminal of the first capacitor Cst1 may also be directly connected to the source of the drive transistor DTFT. The driving timing corresponding to the pixel circuit shown in FIG. 10 may still refer to FIG. 9, and the differences in the driving process lie in: in the threshold compensation stage T2, the discharge path of the drive transistor DTFT directly passes through the fourth transistor M4 and no longer passes through the eleventh transistor M11, and the second reference signal Vref2 is transmitted to the anode of the light-emitting device L after passing through the fourth transistor M4 and the eleventh transistor M11 sequentially.

The preceding embodiments illustrate the solution where the transistors in the pixel circuit are all n-type transistors, which should not be construed as limiting the present application. In other embodiments, some or all of the transistors may be replaced with p-type transistors according to the requirements, and the potentials of the control signals accessed to the transistors may be adjusted accordingly.

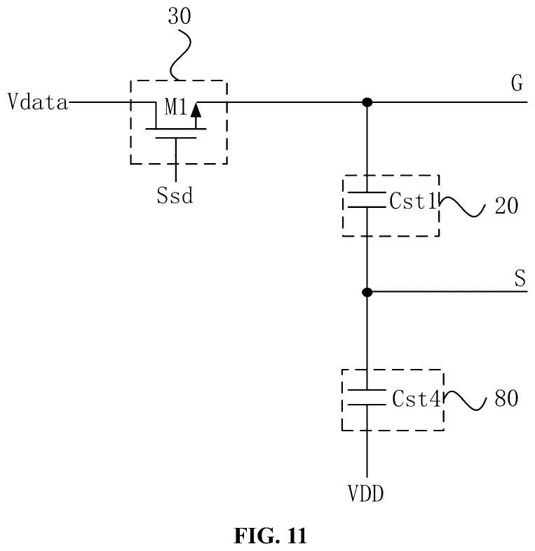

FIG. 11 is a structural diagram of another pixel circuit according to an embodiment of the present application. With reference to FIG. 11, in another embodiment, optionally, the second terminal of the locking control circuit 30 accesses the data signal Vdata. FIG. 11 mainly shows the structure related to the data writing process in the pixel circuit. For example, in addition to the first storage circuit 20 and the locking control circuit 30, the structure related to the data writing process further includes a fourth storage circuit 80. A first terminal of the fourth storage circuit 80 is electrically connected to the second terminal of the first storage circuit 20, and a second terminal of the fourth storage circuit 80 is electrically connected to the first power supply and accesses the first power supply signal VDD. The fourth storage circuit 80 includes a fourth capacitor Cst4. A first terminal of the fourth capacitor Cst4 serves as the first terminal of the fourth storage circuit 80, and a second terminal of the fourth capacitor Cst4 serves as the second terminal of the fourth storage circuit 80.

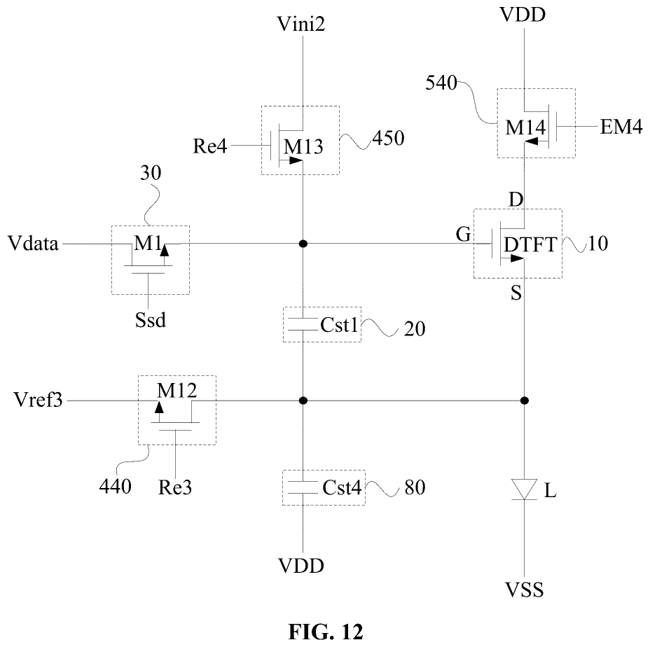

The application of the above data write structure is described below in conjunction with the pixel circuit employing the structure. FIG. 12 is a structural diagram of another pixel circuit according to an embodiment of the present application. With reference to FIG. 12, on the basis of the preceding embodiments, optionally, the pixel circuit further includes a fourth reset circuit 440, a fifth reset circuit 450, and a fourth light emission control circuit 540. The fourth reset circuit 440 is electrically connected to the second terminal of the first storage circuit 20, the fifth reset circuit 450 is electrically connected to the first terminal of the first storage circuit 20, and the fourth light emission control circuit 540 is connected between the first power supply and the second terminal D of the drive circuit 10.

The fourth reset circuit 440 includes a twelfth transistor M12. A gate of the twelfth transistor M12 accesses a third control signal Re3, a first electrode of the twelfth transistor M12 accesses a third reference signal Vref3, and a second electrode of the twelfth transistor M12 is electrically connected to the second terminal of the first capacitor Cst1. The fifth reset circuit 450 includes a thirteenth transistor M13. A gate of the thirteenth transistor M13 accesses a fourth control signal Re4, a first electrode of the thirteenth transistor M13 accesses a third reset signal Vini2, and a second electrode of the thirteenth transistor M13 is electrically connected to the first terminal of the first capacitor Cst1. A gate of the fourth light emission control unit 540 accesses a fourth light emission control signal EM4. The fourth light emission control unit 540 includes a fourteenth transistor M14. A first electrode of the fourteenth transistor M14 accesses the first power supply signal VDD, and a second electrode of the fourteenth transistor M14 is electrically connected to the drain of the drive transistor DTFT. The second terminal of the first capacitor Cst1 is directly electrically connected to the source of the drive transistor DTFT and the anode of the light-emitting device L. The third reference signal Vref3 and the third reset signal Vini2 may each be a direct current signal having a fixed potential.

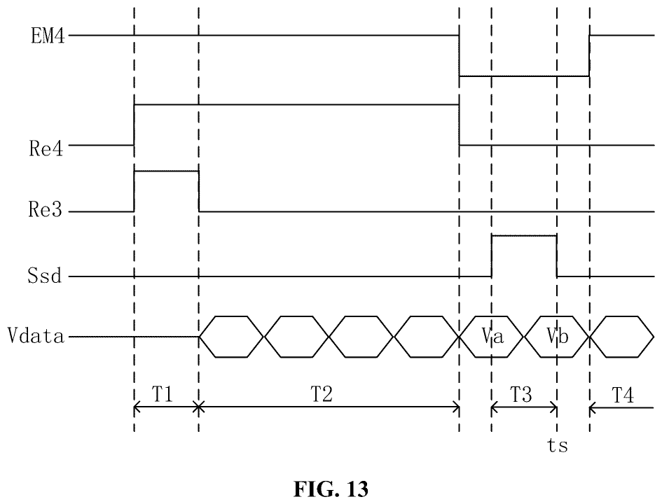

FIG. 13 is a driving timing graph of another pixel circuit according to an embodiment of the present application. In conjunction with FIGS. 12 and 13, taking the transistors all being n-type transistors as an example, the driving process of the pixel circuit includes an initialization stage T1, a threshold compensation stage T2, a data write stage T3, and a light emission stage T4.

In the initialization stage T1, the locking control signal Ssd is at a logic low potential, and the third control signal Re3, the fourth control signal Re4, and the fourth light emission control signal EM4 are each at a logic high potential. The first transistor M1 is turned off, and the twelfth transistor M12, the thirteenth transistor M13, and the fourteenth transistor M14 are all turned on. The third reference signal Vref3 is transmitted to the second terminal of the first capacitor Cst1, the first terminal of the fourth capacitor Cst4, and the anode of the light-emitting device L after passing through the twelfth transistor M12. The third reset signal Vini2 is transmitted to the first terminal of the first capacitor Cst1 after passing through the thirteenth transistor M13, and the first power supply signal VDD is transmitted to the drain of the drive transistor DTFT after passing through the fourteenth transistor M14. In the initialization stage, the first capacitor Cst1, the fourth capacitor Cst4, and the anode of the light-emitting device L are all reset.

In the threshold compensation stage T2, the third control signal Re3 changes to a logic low potential. The twelfth transistor M12 is turned off, the first power supply signal VDD continues to be transmitted to the drain of the drive transistor DTFT after passing through the fourteenth transistor M14, and the third reset signal Vini2 continues to be transmitted to the first terminal of the first capacitor Cst1 after passing through the thirteenth transistor M13. The drive transistor DTFT is turned on, the first power supply signal VDD charges the source of the drive transistor DTFT through the fourteenth transistor M14 and the drive transistor DTFT, the potential at the source of the drive transistor DTFT is gradually raised until the drive transistor DTFT is turned off, and then the threshold compensation to the drive transistor DTFT is complete. At this point, the stored potential difference between two terminals of the first capacitor Cst1 is the threshold voltage Vth1 of the drive transistor DTFT.

In the data write stage T3, when the data write stage is just entered, the locking control signal Ssd is at a logic high potential, and the third control signal Re3, the fourth control signal Re4, and the fourth light emission control signal EM4 are each at a logic low potential. The first transistor M1 is turned on, and the twelfth transistor M12, the thirteenth transistor M13, and the fourteenth transistor M14 are all turned off. The data signal Vdata is transmitted to the first terminal of the first capacitor Cst1 after passing through the first transistor M1, and the potential at the first terminal of the third capacitor Cst3 jumps from the third reset signal Vini2 to the data signal Vdata. The fourth capacitor Cst4 is connected to the first power supply signal VDD to control the potential jump amount on the first capacitor Cst1. The voltage drop between the two terminals of the first capacitor Cst1 is: (Vdata−Vini2)·(Cst4+Coled)/(Cst4+Vgs+Cst1+Coled)+Vth1, where Cgs denotes the capacitance between the gate of the drive transistor DTFT and the source of the drive transistor DTFT, and Coled denotes the parasitic capacitance of the light-emitting device L. In this embodiment, the fourth capacitor Cst4 is set mainly to provide a larger scale factor, that is, to make (Cst4+Coled)/(Cst4+Vgs+Cst1+Coled) larger, thereby ensuring the data voltage writing sensitivity and reducing the variation range of the data voltage.

At the signal locking occasion ts, the locking control signal Ssd falls to a logic low potential, the first transistor M1 is turned off, the first terminal of the first capacitor Cst1 is in a floating state, and the data signal source of the first capacitor Cst1 is cut off. At this point, the data signal Vdata maintains the data voltage Vb, and thus the potential difference between the two terminals of the first capacitor Cst1 is locked as: (Vb−Vini2)·(Cst4+Coled)/(Cst4+Vgs+Cst1+Coled)+Vth1. That is, both the information about the data signal Vdata of the current row and the threshold voltage information of the drive transistor DTFT are stored in the first capacitor Cst1, and then the data writing process is completed.

In the light emission stage T4, the fourth light emission control signal EM4 is at a logic high potential, and the locking control signal Ssd, the third control signal Re3, and the fourth control signal Re4 are each at a logic low potential. The fourteenth transistor M14 is turned on, and the drive transistor DTFT generates a drive current to illuminate the light-emitting device L. The drive current is a function of Vgs-Vth1, where Vgs is equal to the voltage difference between the two terminals of the first capacitor Cst1. Therefore, the drive current is actually a function of Vdata-Vini2, and the magnitude of the drive current is independent of the threshold voltage Vth1 of the drive transistor DTFT.

The preceding embodiments illustrate the solution where the transistors in the pixel circuit are all n-type transistors, which should not be construed as limiting the present application. In other embodiments, some or all of the transistors may be replaced with p-type transistors according to the requirements, and the potentials of the control signals accessed to the transistors may be adjusted accordingly.

In summary, the embodiments of the present application provide a new data write structure and related driving timings, which may be applied to multiple types of pixel circuits to address the issue of poor data writing effects in the related art. In the data writing process in the related art, the data writing path needs to pass through the channel of the drive transistor, and thus the data signal needs to maintain the data voltage required for the current row of pixel circuits in the data write stage of the current row of pixel circuits. The data voltage of an adjacent row is prohibited from entering the current row to avoid the failure to properly write the data voltage of the current row due to the inability of the data voltage of the current row to activate the drive transistor when the data voltage of a previous row is written or prevent the data voltage of a next row from re-activating the drive transistor and being erroneously written. Therefore, the width of the on-pulse of the scanning signal cannot exceed the row duration, and at least the duration in which the gate of the drive transistor is charged from its initial potential to the sum of the data voltage and the threshold voltage of the drive transistor before being turned off needs to be maintained in the data writing process, which limits the data writing speed of the pixel circuit. As the demands of users for the display quality and the functionality of the display panel increase, the row duration is continuously reduced. The shorter row duration may prematurely terminate the data write stage, the data voltage fails to be fully written to the gate of the drive transistor, and the data writing effect is compromised. Further, due to process limitations and the impact of the parasitic capacitance, the scanning circuit struggles to generate scanning signals having an excessively narrow width of the on-pulse, and when the row duration is shorter, the scanning circuit cannot stably provide scanning signals, thereby further degrading the data writing effect.

The data write structure provided by the embodiments of the present application utilizes the potential jumping edge of the locking control signal to sample the data signal, thereby achieving an extremely short sampling duration and an extremely fast sampling speed during data writing. Meanwhile, the width of the on-pulse of the scanning signal is allowed to exceed the row duration, and even in high refresh rate scenarios, the need to provide scanning signals having an excessively narrow pulse width is eliminated, thereby simplifying the designs of the pixel circuit and the scanning circuit under such high refresh rate scenarios. The pixel circuit employing the data write structure enables the separation between the threshold compensation stage and the data write stage, and the threshold compensation duration may be free from the constraints of the row duration and thus prolonged, thereby achieving a good compensation effect and enhancing display uniformity. Further, the threshold compensation stages of different rows of pixel circuits are allowed to temporally overlap, and the prolonging of the threshold compensation duration does not affect the refresh frequency of the display panel. Therefore, the pixel circuit provided by the embodiments of the present application can improve the data writing effect and the threshold compensation effect and simultaneously achieve a high refresh rate and a high resolution of the display panel.

The embodiments of the present application further provide a method for driving a pixel circuit. The driving method is used for driving the pixel circuit provided by any embodiment of the present application and has corresponding effects. The driving method may include a data write stage and a light emission stage, where the data write stage includes a signal locking occasion. For example, the driving method includes the following.

In the data write stage, the locking control signal controls the locking control circuit to be turned on before the signal locking occasion so that the potential difference between two terminals of the first storage circuit changes with the change of the data signal.

At the signal locking occasion, potential jumping is performed on the locking control circuit, the locking control circuit is controlled to be turned off so that the potential at the control terminal of the drive circuit is in a floating state, and the first storage circuit stores a voltage associated with the data signal accessed at the signal locking occasion.

In the light emission stage, the drive circuit generates a drive current according to the voltage stored by the first storage circuit at the signal locking occasion to drive the light-emitting device to emit light.

The method for driving a pixel circuit provided by the embodiments of the present application provides a new data writing mode, and the data writing path in the pixel circuit passes through the first storage circuit and the locking control circuit and does not need to pass through the drive circuit. By controlling the locking control circuit to change from the on state to the off state at the signal locking occasion, the data information at the occasion may be locked so that the first storage circuit may quickly and correctly store the voltage associated with the data signal accessed at the signal locking occasion. By setting the data write stage to include the signal locking occasion and the signal locking occasion to be within the row duration during which the data signal maintains the data voltage required for the current row of pixel circuits, the correct data writing process can be achieved. The duration of the data write stage is not limited in this embodiment, and data voltage information of an adjacent row is allowed to enter the current row of pixel circuits in the data write stage, so the width of the on-pulse of the control signal related to the data writing process may be greater than the row duration, thereby effectively reducing the risk of malfunctions of a scanning circuit for providing the control signal, improving the stability of the control signal, and ensuring the data writing effect. Therefore, the embodiments of the present application can improve the data writing effect of the display circuit, thereby enhancing the display effect of the display panel.

In the embodiments of the pixel circuit, driving methods have been described for different pixel circuits. These driving methods may all be considered as the methods for driving a pixel circuit provided by the embodiments of the present application, and repeated content is not described here.

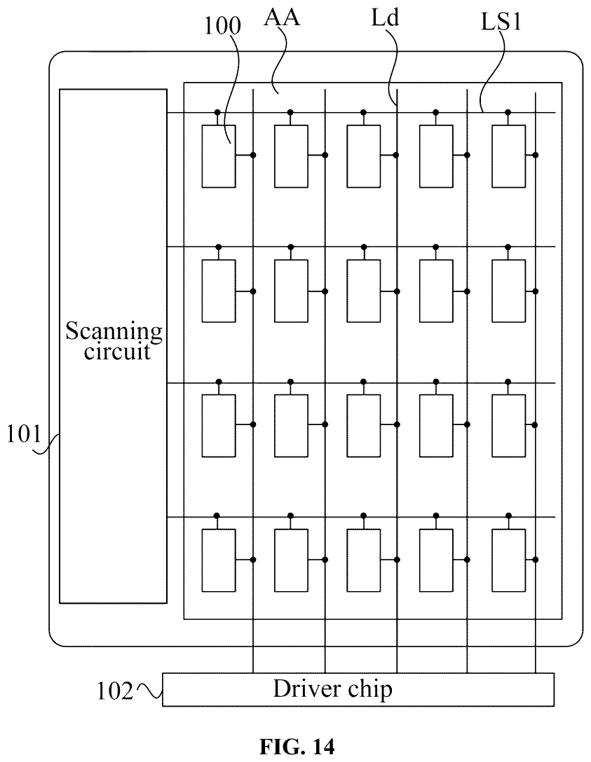

The embodiments of the present application further provide a display panel. The display panel includes the pixel circuit provided by any embodiment of the present application and has corresponding effects. FIG. 14 is a structure diagram of a display panel according to an embodiment of the present application. With reference to FIG. 14, for example, multiple pixel circuits 100 are arranged in an array in a display region AA of the display panel. The display panel further includes a scanning circuit 101 and multipole first scan lines LS1. The scanning circuit 101 is configured to provide locking control signals for the pixel circuits 100 through the first scan lines LS1. The display panel further includes a driver chip 102 and multiple data lines Ld. The driver chip 102 is configured to provide data signals for the pixel circuits 100 through the data lines Ld.

What is claimed is:

1. A pixel circuit, comprising:
a drive circuit, configured to generate a drive current according to a potential difference between a control terminal of the drive circuit and a first terminal of the drive circuit to drive a light-emitting device to emit light;
a first storage circuit, wherein a first terminal of the first storage circuit is electrically connected to the control terminal of the drive circuit, and a second terminal of the first storage circuit is electrically connected to the first terminal of the drive circuit; and
a locking control circuit, wherein a control terminal of the locking control circuit is configured to access a locking control signal, and a first terminal of the locking control circuit is electrically connected to the control terminal of the drive circuit; the second terminal of the first storage circuit or a second terminal of the locking control circuit is configured to access a data signal;
wherein the locking control circuit is configured to be turned off at a signal locking occasion in response to the locking control signal, and a potential at the control terminal of the drive circuit is in a floating state; and the first storage circuit is configured to store a voltage associated with the data signal accessed at the signal locking occasion.

2. The pixel circuit according to claim 1, wherein the first storage circuit comprises a first capacitor, a first terminal of the first capacitor serves as the first terminal of the first storage circuit, and a second terminal of the first capacitor serves as the second terminal of the first storage circuit;
wherein the locking control circuit comprises a first transistor, a gate of the first transistor serves as the control terminal of the locking control circuit, a first electrode of the first transistor serves as the first terminal of the locking control circuit, and a second electrode of the first transistor serves as the second terminal of the locking control circuit.

3. The pixel circuit according to claim 1, wherein the second terminal of the first storage circuit is configured to access the data signal, and the second terminal of the locking control circuit is configured to be connected to a first reference signal line;
wherein the pixel circuit further comprises:
a first data transmission circuit, wherein the first data transmission circuit is configured to be turned on in a data write stage and transmit the data signal to an output terminal of the first data transmission circuit, and the data write stage comprises the signal locking occasion; and
a second storage circuit, wherein the second storage circuit is connected between the output terminal of the first data transmission circuit and the second terminal of the first storage circuit and configured to couple a potential jump at the output terminal of the first data transmission circuit to the second terminal of the first storage circuit.

4. The pixel circuit according to claim 3, further comprising:
a first reset circuit, wherein the first reset circuit is electrically connected to the output terminal of the first data transmission circuit and configured to be turned on before the data write stage and reset the second storage circuit by using a first reset signal;
a second reset circuit, wherein the second reset circuit is electrically connected to a second terminal of the drive circuit and configured to be turned on in a threshold compensation stage to cause the first terminal of the drive circuit to discharge through the drive circuit and the second reset circuit, and the first storage circuit stores a threshold voltage of the drive circuit; wherein the threshold compensation stage is set before the data write stage; and
a first light emission control circuit, wherein the first light emission control circuit is connected in series with the drive circuit and the light-emitting device between a first power supply and a second power supply and configured to be turned on in an initialization stage and a light emission stage; wherein the initialization stage is set before the threshold compensation stage, and the light emission stage is set after the data write stage.

5. The pixel circuit according to claim 1, wherein the second terminal of the locking control circuit is configured to access the data signal;
the pixel circuit further comprises:
a second data transmission circuit, wherein the second data transmission circuit is configured to be turned on in a data write stage and transmit the data signal to an output terminal of the second data transmission circuit, and the data write stage comprises the signal locking occasion;
a third storage circuit, wherein the third storage circuit is connected between the output terminal of the second data transmission circuit and the second terminal of the locking control circuit and configured to couple a potential jump at the output terminal of the second data transmission circuit to the second terminal of the locking control circuit; and
a reference signal transmission circuit, wherein the reference signal transmission circuit is configured to be turned on in response to a transmission control signal and transmit a second reference signal to the second terminal of the first storage circuit;
wherein the reference signal transmission circuit and the locking control circuit are turned off simultaneously or the reference signal transmission circuit is turned off later than the locking control circuit.

6. The pixel circuit according to claim 5, wherein the locking control signal is reused as the transmission control signal.

7. The pixel circuit according to claim 5, further comprising:
a third reset circuit, wherein the third reset circuit is electrically connected to the output terminal of the second data transmission circuit and configured to reset the third storage circuit by using a second reset signal before the data write stage;
a second light emission control circuit, wherein the second light emission control circuit is connected between a first power supply and a second terminal of the drive circuit and configured to be turned on in a light emission stage; wherein the light emission stage is set after the data write stage; and
a third light emission control circuit, wherein the third light emission control circuit is connected between the first terminal of the drive circuit and an anode of the light-emitting device and configured to be turned on before the data write stage and in the light emission stage;
wherein the second terminal of the first storage circuit is directly electrically connected to the first terminal of the drive circuit or electrically connected to the first terminal of the drive circuit through the third light emission control circuit.

8. The pixel circuit according to claim 7, wherein a control terminal of the third reset circuit and the control terminal of the third light emission control circuit are connected to a same control signal line.

9. The pixel circuit according to claim 1, wherein the second terminal of the locking control circuit is configured to access the data signal;
the pixel circuit further comprises:
a fourth storage circuit, wherein a first terminal of the fourth storage circuit is electrically connected to the second terminal of the first storage circuit, and a second terminal of the fourth storage circuit is electrically connected to a first power supply.

10. The pixel circuit according to claim 9, further comprising:
a fourth reset circuit, wherein the fourth reset circuit is electrically connected to the second terminal of the first storage circuit and configured to be turned on in an initialization stage and turned off in a threshold compensation stage; wherein the threshold compensation stage is set before a data write stage, the initialization stage is set before the threshold compensation stage, and the data write stage comprises the signal locking occasion;
a fifth reset circuit, wherein the fifth reset circuit is electrically connected to the first terminal of the first storage circuit and configured to be turned on before the data write stage and transmit a third reset signal to the first terminal of the first storage circuit; and
a fourth light emission control circuit, wherein the fourth light emission control circuit is connected between a first power supply and a second terminal of the drive circuit and configured to be turned on before the data write stage and in a light emission stage, and the light emission stage is set after the data write stage.

11. The pixel circuit according to claim 3, wherein the first data transmission circuit comprises a second transistor, a gate of the second transistor is configured to be connected to a first scan line, a first electrode of the second transistor is configured to be connected to a data line, and a second electrode of the second transistor serves as the output terminal of the first data transmission circuit;
wherein the second storage circuit comprises a second capacitor, a first terminal of the second capacitor is electrically connected to the output terminal of the first data transmission circuit, and a second terminal of the second capacitor is electrically connected to the second terminal of the first storage circuit.

12. The pixel circuit according to claim 5, wherein the second data transmission circuit comprises a third transistor, a gate of the third transistor is configured to be connected to a second scan line, a first electrode of the third transistor is configured to be connected to a data line, and a second electrode of the third transistor serves as the output terminal of the second data transmission circuit;
wherein the third storage circuit comprises a third capacitor, a first terminal of the third capacitor is electrically connected to the output terminal of the second data transmission circuit, and a second terminal of the third capacitor is electrically connected to the second terminal of the locking control circuit;
wherein the reference signal transmission circuit comprises a fourth transistor, a gate of the fourth transistor is configured to be connected to a transmission control signal line, a first electrode of the fourth transistor is connected to a second reference signal line, and a second electrode of the fourth transistor is connected to the second terminal of the first storage circuit.

13. The pixel circuit according to claim 9, wherein the fourth storage circuit comprises a fourth capacitor, wherein a first terminal of the fourth capacitor serves as the first terminal of the fourth storage circuit, and a second terminal of the fourth capacitor serves as the second terminal of the fourth storage circuit.

14. A display panel, comprising a pixel circuit, wherein the pixel circuit comprises:
a drive circuit, configured to generate a drive current according to a potential difference between a control terminal of the drive circuit and a first terminal of the drive circuit to drive a light-emitting device to emit light;
a first storage circuit, wherein a first terminal of the first storage circuit is electrically connected to the control terminal of the drive circuit, and a second terminal of the first storage circuit is electrically connected to the first terminal of the drive circuit; and
a locking control circuit, wherein a control terminal of the locking control circuit is configured to access a locking control signal, and a first terminal of the locking control circuit is electrically connected to the control terminal of the drive circuit; the second terminal of the first storage circuit or a second terminal of the locking control circuit is configured to access a data signal;
wherein the locking control circuit is configured to be turned off at a signal locking occasion in response to the locking control signal, and a potential at the control terminal of the drive circuit is in a floating state; and the first storage circuit is configured to store a voltage associated with the data signal accessed at the signal locking occasion.

15. The display panel according to claim 14, wherein the first storage circuit comprises a first capacitor, a first terminal of the first capacitor serves as the first terminal of the first storage circuit, and a second terminal of the first capacitor serves as the second terminal of the first storage circuit;
wherein the locking control circuit comprises a first transistor, a gate of the first transistor serves as the control terminal of the locking control circuit, a first electrode of the first transistor serves as the first terminal of the locking control circuit, and a second electrode of the first transistor serves as the second terminal of the locking control circuit.

16. The display panel according to claim 14, wherein the second terminal of the first storage circuit is configured to access the data signal, and the second terminal of the locking control circuit is configured to be connected to a first reference signal line;
wherein the pixel circuit further comprises:
a first data transmission circuit, wherein the first data transmission circuit is configured to be turned on in a data write stage and transmit the data signal to an output terminal of the first data transmission circuit, and the data write stage comprises the signal locking occasion; and
a second storage circuit, wherein the second storage circuit is connected between the output terminal of the first data transmission circuit and the second terminal of the first storage circuit and configured to couple a potential jump at the output terminal of the first data transmission circuit to the second terminal of the first storage circuit.

17. The display panel according to claim 16, further comprising:
a first reset circuit, wherein the first reset circuit is electrically connected to the output terminal of the first data transmission circuit and configured to be turned on before the data write stage and reset the second storage circuit by using a first reset signal;
a second reset circuit, wherein the second reset circuit is electrically connected to a second terminal of the drive circuit and configured to be turned on in a threshold compensation stage to cause the first terminal of the drive circuit to discharge through the drive circuit and the second reset circuit, and the first storage circuit stores a threshold voltage of the drive circuit; wherein the threshold compensation stage is set before the data write stage; and
a first light emission control circuit, wherein the first light emission control circuit is connected in series with the drive circuit and the light-emitting device between a first power supply and a second power supply and configured to be turned on in an initialization stage and a light emission stage; wherein the initialization stage is set before the threshold compensation stage, and the light emission stage is set after the data write stage.

18. The display panel according to claim 14, wherein the second terminal of the locking control circuit is configured to access the data signal;
the pixel circuit further comprises:
a second data transmission circuit, wherein the second data transmission circuit is configured to be turned on in a data write stage and transmit the data signal to an output terminal of the second data transmission circuit, and the data write stage comprises the signal locking occasion;
a third storage circuit, wherein the third storage circuit is connected between the output terminal of the second data transmission circuit and the second terminal of the locking control circuit and configured to couple a potential jump at the output terminal of the second data transmission circuit to the second terminal of the locking control circuit; and
a reference signal transmission circuit, wherein the reference signal transmission circuit is configured to be turned on in response to a transmission control signal and transmit a second reference signal to the second terminal of the first storage circuit;
wherein the reference signal transmission circuit and the locking control circuit are turned off simultaneously or the reference signal transmission circuit is turned off later than the locking control circuit.

19. The display panel according to claim 18, wherein the locking control signal is reused as the transmission control signal.

20. A method for driving a pixel circuit, configured to drive the pixel circuit according to claim 1 and comprising a data write stage and a light emission stage; wherein the data write stage comprises a signal locking occasion;
in the data write stage, the locking control signal controls the locking control circuit to be turned on before the signal locking occasion, and a potential difference between two terminals of the first storage circuit changes with a change of the data signal;
at the signal locking occasion, potential jumping is performed on the locking control circuit, the locking control circuit is controlled to be turned off, a potential at the control terminal of the drive circuit is in a floating state, and the first storage circuit stores a voltage associated with the data signal accessed at the signal locking occasion; and
in the light emission stage, the drive circuit generates a drive current according to the voltage stored by the first storage circuit at the signal locking occasion to drive the light-emitting device to emit light.
